(19) United States
(12) Patent Application Publication
(10) Pub. No.: US 2022/0373349 A1
(43) Pub. Date: Nov. 24, 2022

(54) NAVIGATION DEVICE

(71) Applicant: Faurecia Clarion Electronics Co., Ltd., Saitama-shi (JP)

(72) Inventors: Hiroyasu SATO, Saitama (JP); Atsushi KUBO, Saitama (JP)

(73) Assignee: Faurecia Clarion Electronics Co., Ltd., Saitama-shi (JP)

(21) Appl. No.: 17/746,107

(22) Filed: May 17, 2022

(30) Foreign Application Priority Data
May 20, 2021 (JP) 2021-085667

(51) Int. Cl. G01C 21/36; G06V 20/58; G06V 20/62

(52) U.S. Cl. CPC G01C 21/3623; G06V 20/582; G06V 20/62; G06V 2201/09

(57) ABSTRACT

To enable guidance to be given more understandably, depending on the guidance location.

Provision of an image recognizing unit for analyzing the state of a guidance object that serves as a landmark for a guidance location, through image recognition using an image captured for the direction forward of a vehicle; a guidance information generating unit for generating guidance information that includes a supplementary explanation regarding the state of the guidance object, depending on the result of the analysis; and an output processing unit for outputting the guidance information.

### FIELD OF TECHNOLOGY

The present invention relates to a navigation device.

### PRIOR ART

Patent Document 1 relates to a route guidance system, and is described as “capturing and storing, at predetermined intervals, images to the front of a vehicle, from a predetermined distance Lim from a guidance intersection, performing image recognition by comparing each captured image to a landmark standard template for guidance intersections (branching points), to recognize the image if greater than a matching ratio P (80%). If an image has been recognized by the matching ratio P, image recognition is performed with a matching rate Q (20%) with captured images, working backwards sequentially toward the past as subject images, where, of the imaging locations of captured images that can be recognized by the matching ratio Q, the location that is furthest from the guidance intersection is defined as the distance over which visual recognition is possible. Given this, if no distance wherein visual recognition is possible is stored in the intersection landmark information for a guidance intersection (if troubled for the first time), normal voice instruction is performed using distance and direction. On the other hand, if the distance over which visual recognition is possible has been stored, voice instruction is given using a landmark if further, from the guidance intersection, than the distance for which visual recognition is possible.”

### PRIOR ART DOCUMENT

### Patent Document

[Patent Document 1] Japanese Unexamined Patent Application Publication 2014-173956

### SUMMARY OF THE INVENTION

### Problem Solved by the Present Invention

There are technologies for providing guidance using landmarks that exist in guidance locations, in order to provide easily understood guidance for travel route directions (right/left turns, or the like) at guidance locations such as intersections. However, it is difficult for the user to see the facilities or the like serving as landmarks depending on the state at the time of guiding. Therefore, there is a problem that the guide using landmarks becomes difficult to understand.

Patent Document 1 discloses a technology wherein guidance is performed using landmarks conditionally upon passing through locations corresponding to distances at which they are visually recognizable, when there are distances at which visual recognition is possible for landmarks at guidance locations. However, there is no description regarding performing guidance that, for ease in understanding, takes into account the state of the landmark.

Given this, the object of the present invention is to perform more easily understood guidance at a guidance location.

### Means for Solving the Problem

The present application includes a plurality of means for solving, at least partially, the problem set forth above, and an example thereof is given below. A navigation device according to one aspect of the present invention, by which to solve the problem set forth above, comprises: an image recognizing unit for analyzing a state of a guidance object to serve as a landmark for a guidance location, through image recognition using a captured image forward of the vehicle; a guidance information generating unit for generating guidance information including a supplementary explanation regarding the state of the guidance object depending on the result of the analysis; and an output processing unit for outputting the guidance information.

### Effects of the Invention

The present invention enables more easily understood guidance to be given at a guidance location.

Note that additional problems, structures, effects, and the like will be understood through the explanation of the embodiment below.

### BRIEF DESCRIPTIONS OF THE DRAWINGS

FIG. 1 is a block diagram showing an example of a functional structure of a navigation device.

FIG. 2 is a diagram showing an example of node information.

FIG. 3 is a diagram showing an example of guidance statement information.

FIG. 4 is a flowchart showing an example of a guidance information generating process.

FIG. 5 is a flowchart showing an example of a guidance object state analyzing process.

FIG. 6 is a diagram showing an example of a hardware structure for a navigation device.

### FORMS FOR PERFORMING THE PRESENT INVENTION

An embodiment according to the present invention will be explained below using the drawings.

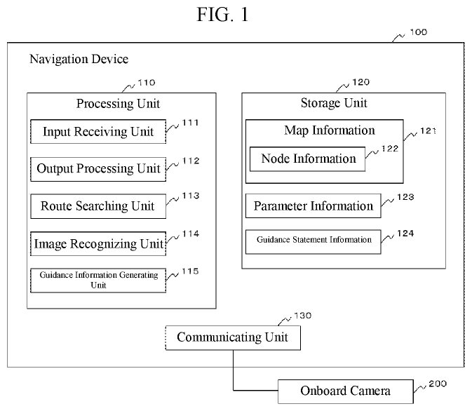

FIG. 1 is a block diagram showing an example of a functional structure for a navigation device 100 according to the present embodiment. Note that the navigation device 100 is an onboard device for performing a variety of processes related to a “navigation function,” such as finding a guidance route that connects, for example, a point of departure (which may be the current location) and a destination, providing route guidance, displaying map information and information for road traffic included in the guidance route, and the like.

As shown, the navigation device 100 has a processing unit 110, a storage unit 120, and a communicating unit 130.

The processing unit 110 is a functional unit for performing the various calculation processes performed by the navigation device 100. Specifically, the processing unit 110 has an input receiving unit 111, an output processing unit 112, a route searching unit 113, an image recognizing unit 114, and a guidance information generating unit 115.

The input receiving unit 111 is a functional unit for receiving inputting of information and instructions. Specifically, the input receiving unit 111 receives inputting of information and instructions from the user through an input device of the navigation device 100.

The output processing unit 112 is a functional unit for outputting various types of information. Specifically, the output processing unit 112 generates screen information for structuring a menu screen, a setting information inputting screen, and a display screen for map information, road traffic information, a guidance route, and the like, and outputs it to a display of the navigation device 100. Additionally, the output processing unit 112 outputs, to a speaker provided by the navigation device 100 (or to an onboard speaker) the guidance information generated by the guidance information generating unit 115.

The route searching unit 113 is a functional unit for finding a guidance route. Specifically, the route searching unit 113 uses the point of departure and destination acquired through the input receiving unit 111, map information, and road traffic information, to search for a guidance route connecting the point of departure to the destination through a predetermined method, such as Dijkstra's algorithm. Note that the guidance route includes guidance locations such as intersections that involve changing the travel route by, for example, turning right or left, and node IDs for the nodes that indicate these guidance locations.

The image recognizing unit 114 is a functional unit for performing image recognizing processing. Specifically, the image recognizing unit 114 uses image information captured by an onboard camera 200 to perform image recognizing processing to attempt to detect a predetermined guidance object that is to serve as the landmark for the guidance location from among objects such as other vehicles, buildings, and the like, that are included in the captured images. Note that the image recognizing process is not limited to a specific technique, but rather may use publicly known image recognition technologies using AI (Artificial Intelligence) using deep learning or template matching through comparing with other images.

The guidance information generating unit 115 is a functional unit for generating guidance information. Specifically, the guidance information generating unit 115 generates guidance information in response to an analysis result on the captured images (the result of the image recognizing process) by the image recognizing unit 114. More specifically, the guidance information generating unit 115 generates guidance information wherein a supplementary explanation regarding the state of the guidance object has been added if the analysis result of the captured image corresponds to any one of “the guidance object cannot be recognized visually,” “the brightness of the guidance object is less than predetermined value,” or “the size of the guidance object is less than predetermined value.”

The storage unit 120 is a functional unit for storing various types of information. Specifically, the storage unit 120 stores map information 121, node information 122 included in the map information 121, parameter information 123, and guidance statement information 124.

The map information 121 is information regarding the roads on the map. Specifically, the map information 121 has link information for roads in the mesh region for each individual mesh region for identifying regions on the map. Note that the link information stores, for example, location coordinates and node IDs for the starting node and ending node that indicate the ends of a road, road type information indicating the type of road, such as a national highway, a toll road, a prefectural highway, or the like, information indicating the name of the road, link-length information indicating the length of the road, travel time information indicating the time required for traveling over the road, and starting connection link/ending connection link information for storing link IDs of other roads connected to the starting node and ending node of the road.

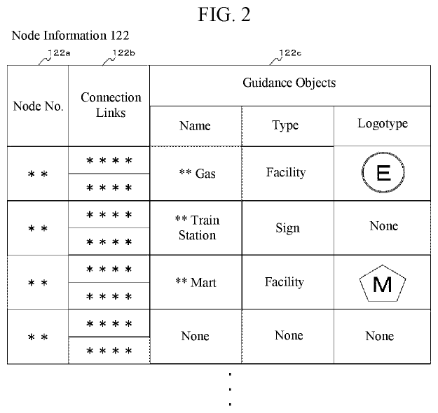

FIG. 2 is a diagram showing an example of node information 122. The node information 122 is information for a node corresponding to a branching point, such as an intersection, or the like, that may serve as a guidance location candidate. Specifically, the node information 122 has records that define correspondences between node Nos. 122a, connection links 122b, and guidance objects 122c that indicate names, types, and logotypes.

Note that node No. 122a is information for identifying each individual node. A connection link 122b is information indicating a link ID for a link that connects to each of the roads, that is, each individual node, linked to a branching point such as an intersection.

The guidance object 122c is information indicating a guidance object to serve as a landmark for each individual node. Specifically, the name is the company name, store name, service brand name, or the like of a company, or the like that runs the facility if the type of guidance object is a facility, or the information indicating the location name on a sign if the type of guidance object is a sign (for example, a signal sign). The type is information indicating the type of guidance object, for example, a facility or a sign. The logotype is a symbol mark indicating the facility or chain of facilities, if the type of guidance object is a facility.

Note that the node information includes nodes for which there are no corresponding guidance objects. “None” is stored for the names, types, and logotypes of guidance objects corresponding to those nodes.

The parameter information 123 is information wherein predetermined parameter values used in the image recognizing processing are stored. Specifically, a brightness parameter value, which is criteria for determination regarding brightness as to whether or not a guidance object would be difficult to see, is stored in the parameter information 123. Moreover, a parameter value that serves as criteria for determination for a size as to whether or not a guidance object would be difficult to see is stored in the parameter information 123.

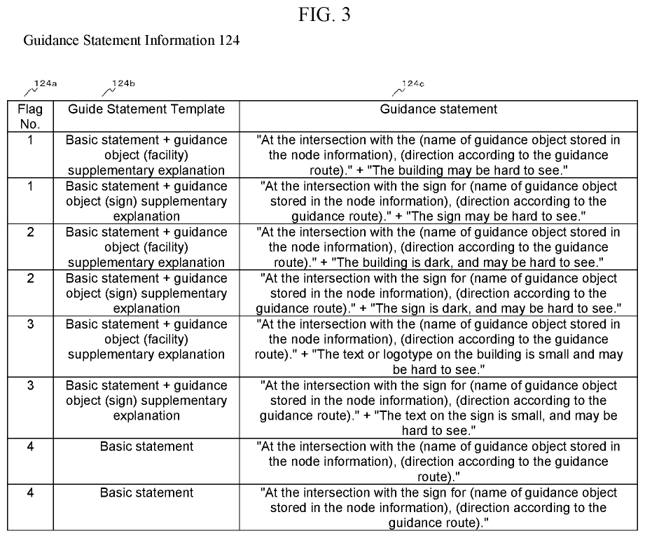

FIG. 3 is a diagram showing an example of guidance statement information 124. The guidance statement information 124 is information for storing guidance statements used in generating the guidance information that includes the guidance object. Specifically, the guidance statement information 124 has records that define the correspondence between a flag No. 124a, a guidance statement template 124b, and a guidance statement 124c.

Note that flag No. 124a is information indicating the corresponding flag number as the analysis result for the captured image. The guidance statement template 124b indicates guidance statement templates relating to combinations of basic statements that are structural elements of the guidance statement, supplementary explanations for guidance objects (facilities), and supplementary explanations for guidance objects (signs).

A guidance statement 124c is information indicating a sentence model that is outputted as guidance information. Sentence models regarding combinations of basic statement units or basic statements, supplementary explanations for guidance objects (facilities), or supplementary explanations for guidance objects (signs) are stored in the guidance statements 124c.

A basic statement is statement with content of, for example, “travel (direction along the guidance direction) through the intersection at the (name of guidance information stored in the node information).” Moreover, the supplementary information for a guidance object (facility) is a sentence with the content that, for example, “the building may be difficult to see,” depending on the corresponding flag number. Additionally, the supplementary explanation for the guidance object (sign) is a sentence with content such as “the sign may be difficult to see,” depending on the corresponding flag number.

Note that the guidance statement information 124 is used where the guidance information generating unit 115 generates guidance information that includes a guidance object.

The communicating unit 130 is a functional unit for performing information communication with external devices. Specifically, the communicating unit 130 acquires, from the onboard camera 200, image information captured at locations that are at predetermined distances from a guidance location (for example, locations at 300 m, 100 m, and 30 m prior to the guidance location).

An example of a functional structure for a navigation device 100 has been explained above.

### Explanation of Operations

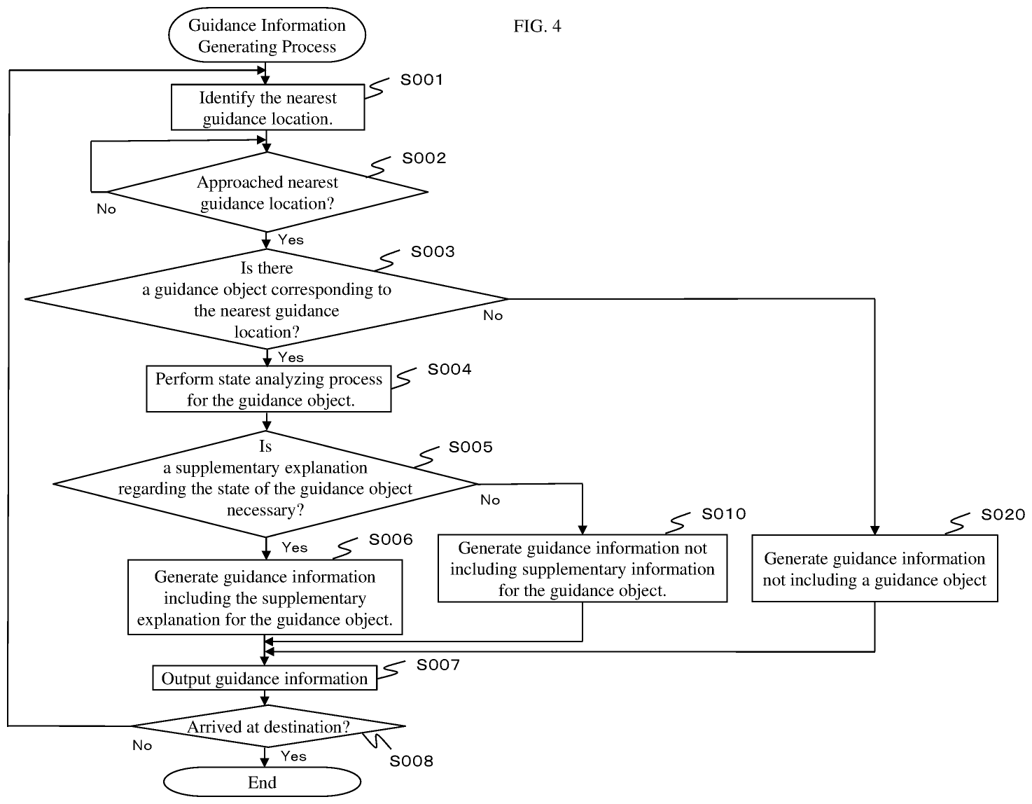

FIG. 4 is a flowchart showing an example of a guideline information generating process. The guideline information generating process is started upon receipt, from a user, of a route guidance start instruction, through the input receiving unit 111, after the route searching unit 113 has found a guidance route.

When processing is started, the guidance information generating unit 115 identifies the nearest guidance location (Step S001). For example, the guidance information generating unit 115 uses map information 121 to identify a nearest guidance location and the node number thereof based on the positional relationship between the vehicle location (the current location of the vehicle) that is identified using output information from a GPS (Global Positioning System) information receiving device that is installed in a navigation device 100 and each guidance location in a guidance route that has been found.

Following this, the guidance information generating unit 115 determines whether or not the nearest guidance location has been approached (Step S002). For example, the guidance information generating unit 115 determines that the nearest guidance location has been approached when the vehicle location has arrived at each of the locations that are predetermined distances before the nearest guidance location (for example, respective locations at 300 m, 100 m, and 30 m before the guidance location).

Given this, if the determination is that the nearest guidance location has been approached (Step S002: YES), the guidance information generating unit 115 moves processing to Step S003. On the other hand, if the determination is that the nearest guidance location has not been approached (Step S002: NO), the guidance information generating unit 115 repeats the process in Step S002.

In Step S003, the guidance information generating unit 115 determines whether or not there is a guidance object corresponding to the nearest guidance location. For example, if a guidance object associated with the node number of the node that is the nearest guidance location is stored in the node information 122, the guidance information generating unit 115 determines that there is a guidance object corresponding to the nearest guidance location.

If the determination is that there is a corresponding guidance object (Step S003: YES), the guidance information generating unit 115 identifies, from the node information 122, the name, type, and logotype of the guidance object, and moves processing to Step S004.

On the other hand, if the determination is that there is no corresponding guidance object (Step S003: NO), the guidance information generating unit 115 moves processing to Step S020. Note that in Step S020 the guidance information generating unit 115 generates guidance information that does not include a guidance object. For example, the guidance information generating unit 115 generates voice guidance information that does not include information regarding a guidance object, such as “In 300 m (or 100 m, or “ahead,” or the like), turn left (or right) at the intersection.” Note that a sentence model for this guidance statement may be stored in a storage unit, or may be stored in the guidance statement information 124. Moreover, when the guidance information has been generated, the guidance information generating unit 115 moves processing to Step S007.

Next, in Step S004, to which processing has moved upon determination that there is a guidance object, the image recognizing unit 114 carries out a guidance object state analyzing process.

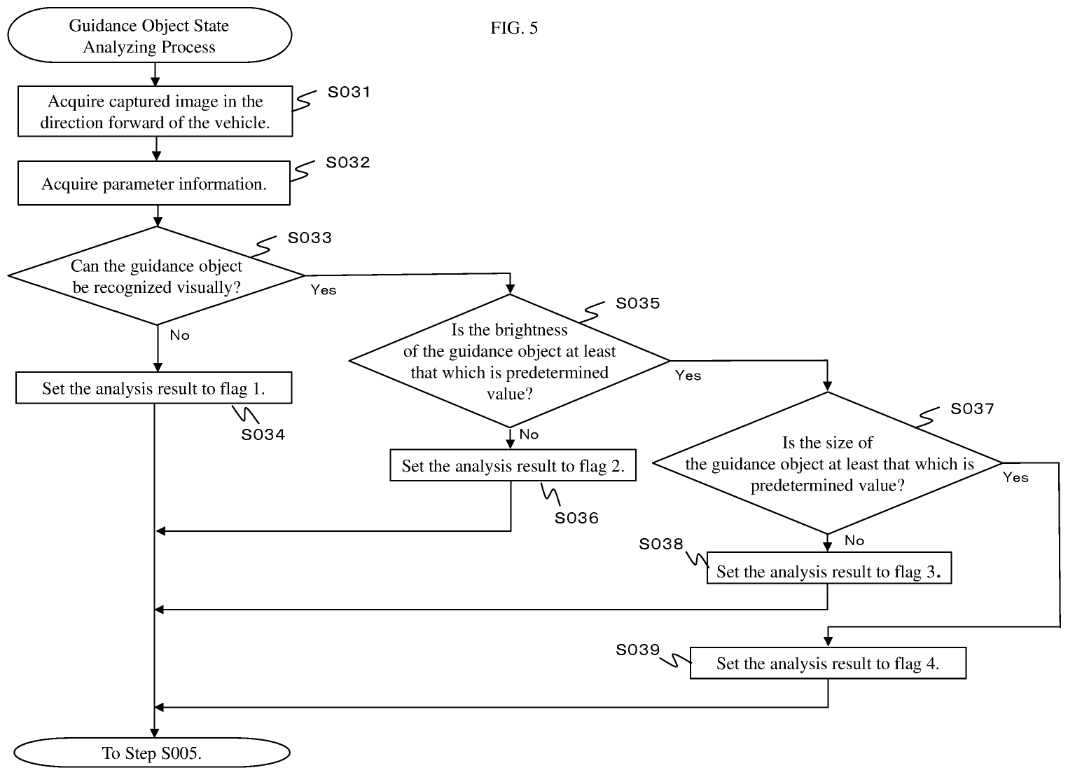

FIG. 5 is a flowchart showing an example of a guidance object state analyzing process. When this process is started, the image recognizing unit 114 acquires a captured image in the direction forward of the vehicle (Step S031). Specifically, the image recognizing unit 114 acquires, from an onboard camera 200 through a communicating unit 130, a captured image of the direction forward of the vehicle, captured at a location a predetermined distance in advance of the guidance location. Additionally, the image recognizing unit 114 acquires parameter information 123 from the storage unit 120 (Step S032).

Next, the image recognizing unit 114 determines whether or not the guidance object can be recognized visually (Step S033). For example, the image recognizing unit 114 carries out an image recognizing process using the captured image that has been acquired, to determine that the guidance object can be identified visually if the guidance object can be recognized from among other objects, such as vehicles, persons, buildings, signs, and the like, that are included in the image.

Specifically, if the type of the guidance object at the nearest guidance location is a facility, the image recognizing unit 114 determines that the guidance object can be recognized visually if the logotype or text indicating the name of the facility can be recognized using the captured image. Moreover, if the type of guidance object at the nearest guidance location is a sign, the image recognizing unit 114 determines that the guidance object can be recognized visually if the text indicating the name of the sign can be recognized from the captured image.

Given this, upon determination that the guidance object can be recognized visually (Step S033: YES), the image recognizing unit 114 moves processing to Step S035.

On the other hand, upon determination that the guidance object cannot be recognized visually (Step S033: NO), for example, if the guidance object cannot be recognized in the captured image when the guidance object is not included in the captured image due to the presence of a preceding vehicle, the image recognizing unit 114 moves processing to Step S034. Note that if, in Step S034, the image recognizing unit 114 could not recognize the guidance object visually, the corresponding flag information (“flag 1” in the present example) is set as the corresponding state analysis result, and processing moves to Step S005.

Next, in Step S035, to which processing was moved when the determination was that the guidance object can be recognized visually (Step S033: YES), the image recognizing unit 114 determines whether or not the brightness of the guidance object is at least that which is predetermined value. For example, the image recognizing unit 114 determines that the brightness of the guidance object is at least that which is predetermined value if the brightness of the guidance object included in the captured image is at least a predetermined parameter value.

Specifically, if the type of guidance object at the nearest guidance location is a facility, the image recognizing unit 114 determines that the brightness of the guidance object is no less than the predetermined value if the brightness of a predetermined region that includes the logotype or text indicating the name of the facility (for example, a signboard with the logotype of the facility or text indicating the name thereof) is no less than a predetermined parameter value. Moreover, if the type of guidance object at the nearest guidance location is a sign, the image recognizing unit 114 determines that the brightness of the guidance object is no less than the predetermined value if the brightness of the sign is no less than the predetermined parameter value.

Additionally, if the brightness of the guidance object is determined as being no less than predetermined value (Step S035: YES), the image recognizing unit 114 moves processing to Step S037.

On the other hand, if the determination is that the brightness of the guidance object is less than predetermined value (Step S035: NO), the image recognizing unit 114 moves processing to Step S036 if, for example, the lights on the signboard with the logotype or name of the guidance object are turned off during nighttime hours after business hours are over. Note that in Step S036, if the brightness of the guidance object is less than the predetermined brightness, the image recognizing unit 114 sets the corresponding flag information (flag 2 in the present example) as the state analysis result, and moves processing to Step S005.

In Step S037, where processing has moved upon determination that the brightness of the guidance object is no less than the predetermined brightness (Step S035: YES), the image recognizing unit 114 determines whether or not the size of the guidance object is at least a predetermined size. For example, the image recognizing unit 114 determines that the size of the guidance object is at least that which is predetermined value if the size of the guidance object included in the captured image is at least a predetermined parameter value.

Specifically, if the type of the guidance object at the nearest guidance location is a facility, the image recognizing unit 114 determines that the size guidance object is no less than the predetermined value if the size of the logotype or the text indicating the name of the facility is no less than a predetermined parameter value. If the type of the guidance object at the nearest guidance location is a sign, the image recognizing unit 114 determines that the size guidance object as no less than the predetermined value if the size of the text indicating the name of the facility is no less than a predetermined parameter value.

Additionally, if the size of the guidance object is determined as being no less than predetermined value (Step S037: YES), the image recognizing unit 114 moves processing to Step S039. Note that in Step S039, if the brightness of the guidance object can be recognized visually and the brightness of the guidance object is no less than is predetermined value, and the size of the guidance object is no less than is predetermined value, the image recognizing unit 114 sets the corresponding flag information (flag 4 in the present example) as the state analysis result, and moves processing to Step S005.

On the other hand, if the determination is that the size of the guidance object is not at least the predetermined size (Step S037: NO), the image recognizing unit 114 moves processing to Step S038 if the size of the logotype or the text indicating the name of the guidance object, for example, or of the text indicating the name of the sign, is extremely small. Note that in Step S038, the image recognizing unit 114 sets the corresponding flag information (flag 3 in the present example), and moves processing to Step S005, as the state analysis result if the size of the guidance object is less than the predetermined size.

In Step S005 (shown in FIG. 4), the guidance information generating unit 115 determines whether or not a supplementary explanation regarding the state of the guidance object is necessary. For example, if any of flags 1 through 3 is set as the state analysis result in Step S004, the guidance information generating unit 115 determines that this supplementary explanation is necessary.

If the determination is that the supplementary explanation is necessary (Step S005: YES), the guidance information generating unit 115 moves processing to Step S006.

On the other hand, if the determination is that the supplementary explanation is not necessary (Step S005: NO), that is, if the flag No. 4 is set as the state analysis result, the guidance information generating unit 115 moves processing to Step S010. Note that in Step S010 the guidance information generating unit 115 generates guidance information that does not include supplementary information for the guidance object.

Specifically, the guidance information generating unit 115 generates guidance information using guidance statement information 124. More specifically, the guidance information generating unit 115 identifies, from the guidance statement information 124, a record for which flag No. 4 is set.

The guidance information generating unit 115 generates guidance information using the guidance statement of the specified record. For example, if the type of guidance object is a facility, the guidance information generating unit 115 generates voice guidance information that does not include supplementary information for a guidance object, following the basic statement of “at the intersection with the (name of guidance object stored in the node information), travel in (the direction according to the guidance route).”

For example, if the type of guidance object is a sign, the guidance information generating unit 115 generates voice guidance information that does not include supplementary information for a guidance object, following the basic statement of “at the intersection with the (name of guidance object stored in the node information) sign, travel in (the direction according to the guidance route).”

Note that the “name of guidance object stored in the node information” in the basic statement is the name of the guidance object stored in the node information 122 for the guidance object at the nearest guidance location. Moreover, the “direction according to the guidance direction” is the direction that indicates the travel route, such as turning right or turning left, following the guidance route.

When guidance information has been generated, the guidance information generating unit 115 moves processing to Step S007.

In Step S006, where processing was moved upon an determination that a supplementary explanation is necessary (Step S005: YES), the guidance information generating unit 115 generates guidance information that includes supplementary information for the guidance object. Specifically, the guidance information generating unit 115 generates guidance information using the guidance statement information 124.

More specifically, the guidance information generating unit 115 identifies, from guidance statement information 124, a record that specifies the flag number that is set in the state analysis result (any of flags 1 through 3) and where correspondence is defined between this flag number and the guidance statement template for the type (facility or sign) corresponding to the guidance object.

Moreover, the guidance information generating unit 115 generates guidance information using the guidance statement of the specified record. For example, if the flag number indicating the state analysis result is 1 and the type of guidance object is a facility, the guidance information generating unit 115 generates voice guidance information wherein the guidance object supplementary information of “the building may be difficult to see” is added to the basic statement.

Moreover, for example, if the flag number indicating the state analysis result is 1 and the type of guidance object is a sign, the guidance information generating unit 115 generates voice guidance information wherein the guidance object supplementary information of “the sign may be difficult to see” is added to the basic statement.

Moreover, for example, if the flag number indicating the state analysis result is 2 and the type of guidance object is a facility, the guidance information generating unit 115 generates voice guidance information wherein the guidance object supplementary information of “the building is dark, and may be difficult to see” is added to the basic statement.

Moreover, for example, if the flag number indicating the state analysis result is 2 and the type of guidance object is a sign, the guidance information generating unit 115 generates voice guidance information wherein the guidance object supplementary information of “the sign is dark, and may be difficult to see” is added to the basic statement.

Moreover, for example, if the flag number indicating the state analysis result is 3 and the type of guidance object is a facility, the guidance information generating unit 115 generates voice guidance information wherein the guidance object supplementary information of “the text or logotype on building is small, and may be difficult to see” is added to the basic statement.

Moreover, for example, if the flag number indicating the state analysis result is 3 and the type of guidance object is a sign, the guidance information generating unit 115 generates voice guidance information wherein the guidance object supplementary information of “the text of the sign is small, and may be difficult to see” is added to the basic statement.

When the guidance information generating unit 115 has generated the guidance information, processing moves to Step S007.

In Step S007, the output processing unit 112 outputs the guidance information that has been generated. Specifically, the output processing unit 112 outputs the guidance information through a speaker 342 equipped in the navigation device 100 or an onboard speaker that can be connected to the navigation device 100 so as to enable communication.

The guidance information generating unit 115 next determines whether or not the vehicle has arrived at the destination (Step S008). Specifically, the guidance information generating unit 115 determines whether or not the vehicle has arrived at the destination, doing so based on the guidance route and the location of the vehicle. If the determination is that the vehicle has arrived (Step S008: YES), the guidance information generating unit 115 terminates processing in this flow. If the determination is that the vehicle has not arrived (Step S008: NO), the guidance information generating unit 115 returns processing to Step S001.

The guidance information generating process has been explained above.

This type of navigation device can perform voice guidance that can be understood more easily depending on the guidance location. In particular, if the facility or sign that serves as the guidance object of the guidance location is difficult to see, the navigation device outputs guidance information that includes a supplementary explanation regarding the state thereof. This makes it possible for the user to identify in advance the possibility that the guidance object that serves as the landmark may be difficult to see, and identifies in what way the state of the guidance object is that of being difficult to see. Through this, the user is able to reference the guidance information to drive to the guidance location without becoming confused.

Note that the present invention is not limited to the embodiment set forth above, but rather may be modified in a variety of ways within the range of the same inventive concept. For example, the navigation device 100 may generate, as guidance information, guidance statements that include respective supplementary information for each of the analysis results from the different aspects in relation to the guidance object.

Specifically, the image recognizing unit 114 may produce analysis results for analyses from different aspects of the brightness and size of the guidance object by performing the processes in Step S037, even if the brightness of the guidance object in Step S035, described above, is less than predetermined value. Given this, the guidance information generating unit 115 generates guidance information for the guidance statement including supplementary information corresponding to each analysis result.

For example, if the brightness of the guidance object is less than predetermined value and the size thereof is less than predetermined value, the guidance information generating unit 115 generates guidance information for a guidance statement that includes, in addition to the basic statement, both a supplemental explanation that “the building is dark and may be difficult to see,” and the supplementary explanation that “the text or logotype on the building is small and may be difficult to see.

Voice guidance that is more easily understood can be performed at the guidance location even with a navigation device according to such a modified example. In particular, the navigation device generating guidance information that includes the respective supplementary information according to the various analysis results for analyses from different aspects enables more detailed guidance regarding the state of the guidance object in terms of how it may be difficult to see.

Moreover, the sentence models in the guidance statement information 124 shown in FIG. 3 are examples, and the sentences may be any sentences insofar as they include content with the same meaning. Moreover, user editing of the sentence models for the guidance statements may also be possible.

The hardware structure of the navigation device 100 will be explained next.

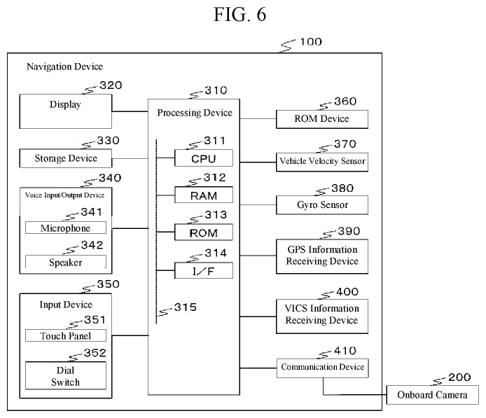

FIG. 6 is a diagram showing an example of a hardware structure for the navigation device 100. As illustrated, the navigation device 100 has a processing device 310, a display 320, a storage device 330, a voice input/output device 340, an input device 350, a ROM device 360, a vehicle velocity sensor 370, a gyro sensor 380, a GPS information receiving device 390, Vehicle Information and Communication System (VICS) information receiving device 400, and a communication device 410.

The processing device 310 has a CPU (Central Processing Unit) 311 for performing calculation processes; a RAM (Random Access Memory) 312 for storing temporarily various types of information read out from the storage device 330 or the ROM device 360; a ROM (Read-Only Memory) 313 for storing programs, or the like, to be performed by the CPU 311; an I/F (interface) 314 for connecting various types of hardware to the processing device 311; and a bus 315 for connecting these together.

Moreover, the display 320 is a unit for displaying graphics information, and is structured from, for example, a liquid crystal display, an organic EL display, or the like. The storage device 330 is at least a readable/writable storage medium, such as an HDD (Hard Disc Drive), an SSD (Solid State Drive), and/or a non-volatile memory card.

The voice input/output device 340 has a microphone 341 for picking up the voice of the driver or a passenger, and a speaker 342 for outputting voice guidance to the driver, and the like. Note that the speaker 342 may be an onboard speaker that is installed in the vehicle.

The input device 350 is a device for receiving instruction input from the user, such as the touch panel 351, a dial switch 352, or the like. The ROM device 360 is at least a readable storage medium such as a CD-ROM or DVD-ROM, or an IC (Integrated Circuit) card, or the like.

The vehicle velocity sensor 370, gyro sensor 380, and GPS information receiving device 390 are used for detecting the current location of the vehicle in which the navigation device 100 is installed. The vehicle velocity sensor 370 outputs information used in calculating the vehicle velocity. The gyro sensor 380 is structured using an optical fiber gyro, a vibration gyro, or the like, to detect angular velocity through rotation of a mobile unit. The GPS information receiving device 390 measures the current location of the vehicle, and the speed and direction of travel, by measuring, for a predetermined number of satellites (for example, four), the distance between the vehicle and the GPS satellites, and the rate of change of that distance, by receiving signals from the GPS satellites.

The VICS information receiving device 400 is a device for receiving road traffic information (VICS information) regarding traffic, accidents, or road construction. The communication device 410 is a device for communicating information with outside devices (for example, the onboard camera 200) through a communication line that connects directly between devices, or through a CAN (Controller Area Network).

Each hardware structure of the navigation device 100 has been explained above.

Note that the processing unit of the navigation device 100 may be achieved through programs that cause processes to be performed in the CPU 311 of the processing device 310. These programs may be stored for example in the storage device 330 or the ROM 313, and, at runtime, loaded into the RAM 312 to be performed by the CPU 311. Moreover, the storage unit 120 may be achieved through a combination of the RAM 312, the ROM 313, and the storage device 330. Additionally, the communicating unit 130 may be achieved through the communication device 410.

For ease in understanding each function achieved in the present embodiment, the various functional blocks of the navigation device 100 have been divided according to the detail of the main processes. Consequently, the present invention is not limited by the method by which the individual functions are divided, nor by the names thereof. Furthermore, each of the structures of the navigation device 100 may be divided into a greater number of structural elements, depending on the details of the processing. Furthermore, a single structural element may be divided so as to perform a greater number of processes.

Additionally, some or all of the various functional units may be structured through hardware devices (such as through integrated circuits known as ASICs) that are installed in a computer. Furthermore, the processes of each functional unit may be performed through a single hardware device, or performed through a plurality of hardware devices.

Additionally, the present invention is not limited to the embodiments, modified examples, and the like, set forth above, but rather includes a variety of other embodiments and modified examples. For example, the embodiment above was explained in detail to facilitate understanding of the present invention, but there is no limitation to necessarily providing all of the structural elements that were described. Moreover, a portion of the structures in a given embodiment may be substituted for structures in another embodiment or modified example, and the structures in one embodiment may be added to the structures in another embodiment. Additionally, some of the structures in each embodiment may be added to, removed from, or substituted with other structures.

### EXPLANATIONS OF REFERENCE SYMBOLS

100: Navigation device

110: Processing Unit

111: Input Receiving Unit

112: Output Processing Unit

113: Route Searching Unit

114: Image Recognizing Unit

115: Guidance Information Generating Unit

120: Storage Unit

121: Map Information

122: Node Information

123: Parameter Information

124: Guidance Statement Information

130: Communicating Unit

200: Onboard Camera

310: Processing device

311: CPU

312: RAM

313: ROM

314: I/F

315: Bus

320: Display

330: Storage Device

340: Voice Input/Output Device

341: Microphone

342: Speaker

350: Input Device

351: Touch Panel

352: Dial Switch

360: ROM Device

370: Vehicle Velocity Sensor

380: Gyro Sensor

390: GPS Information Receiving Device

400: VICS Information Receiving Device

410: Communication Device

1. A navigation device comprising:
an image recognizing unit for analyzing the state of a guidance object that is to serve as a landmark at a guidance location through image recognition using a captured image in the direction forward of a vehicle;
a guidance information generating unit for generating guidance information that includes a supplementary explanation regarding the state of the guidance object depending on the result of the analysis; and
an output processing unit for outputting the guidance information.

2. A navigation device set forth in claim 1, wherein:
the guidance information generating unit generates guidance information that includes the supplementary information for communicating the possibility that the guidance object is in a state that cannot be recognized visually if the guidance object at the guidance location is a predetermined facility and the result of the analysis is that the logotype or text indicating the name of the facility cannot be recognized from the captured image.

3. A navigation device set forth in claim 1, wherein:
the guidance information generating unit generates guidance information that includes the supplementary information for communicating the possibility that the guidance object is in a state that cannot be recognized visually if the guidance object at the guidance location is a predetermined sign and the result of the analysis is that the text indicating the name of the sign cannot be recognized from the captured image.

4. A navigation device set forth in claim 1, wherein:
the guidance information generating unit generates guidance information that includes the supplementary information for communicating the possibility that the guidance object is in a state that is difficult to see if the guidance object at the guidance location is a predetermined facility and the brightness of a predetermined region that includes the logotype or text indicating the name of the facility included in the captured image is less than predetermined value.

5. A navigation device set forth in claim 1, wherein:
the guidance information generating unit generates guidance information that includes the supplementary information for communicating the possibility that the guidance object is in a state that is difficult to see if the guidance object at the guidance location is a predetermined sign and the brightness of the sign included in the captured image is less than predetermined value.

6. A navigation device set forth in claim 1, wherein:
the guidance information generating unit generates guidance information that includes the supplementary information for communicating the possibility that the guidance object is in a state that is difficult to see if the guidance object at the guidance location is a predetermined facility and the size of the logotype or text indicating the name of the facility included in the captured image is less than predetermined value.

7. A navigation device set forth in claim 1, wherein:
the guidance information generating unit generates guidance information that includes the supplementary information for communicating the possibility that the guidance object is in a state that is difficult to see if the guidance object at the guidance location is a predetermined sign and the size of the text indicating the name of the sign included in the captured image is less than predetermined value.

8. A navigation device set forth in claim 1, wherein:
the image recognizing unit uses the captured images to perform analyses from a plurality of different aspects regarding the guidance object; and
the guidance information generating unit generates the guidance information including various supplementary information depending on the result of the analyses from the respective aspects.
